(19) United States
(12) Patent Application Publication
(10) Pub. No.: US 2024/0369120 A1
(43) Pub. Date: Nov. 7, 2024

(54) HYBRID SURFACE LATTICES FOR ADDITIVELY MANUFACTURED PRODUCTS

(71) Applicant: Carbon, Inc., Redwood City, CA (US)

(72) Inventors: Kyle Kloster, East Palo Alto, CA (US); Aidan Kurtz, Hayward, CA (US); Ruiqi Chen, Novi, MI (US); Hardik Kabaria, Redwood City, CA (US); Weixiong Zheng, Freemont, CA (US)

(21) Appl. No.: 18/552,805

(22) PCT Filed: Mar. 30, 2022
(86) PCT No.: PCT/US2022/022509

§ 371 Date: Sep. 27, 2023

Related U.S. Application Data
(60) Provisional application No. 63/169,382, filed on Apr. 1, 2021.

(51) Int. Cl. F16F 9/00; B29C 64/386; B33Y 10/00; B33Y 50/00; B33Y 80/00; F16F 9/30

(52) U.S. Cl. CPC F16F 9/003; B29C 64/386; F16F 9/30; B33Y 10/00; B33Y 50/00; B33Y 80/00

(57) ABSTRACT

An additively manufactured product comprises a lattice including repeating unit cells, the repeating unit cells including a hybrid surface lattice unit cell, the hybrid surface lattice unit cell having a configuration represented by an interpolation of a first and second surface lattice unit cell, the hybrid surface lattice unit cell having a characteristic tensile and/or mechanical property (e.g., stiffness, energy absorption, energy return, resilience, toughness) along a predefined axis therein not achieved by either said first or second surface lattice unit cell when formed from the same material as said hybrid surface lattice unit cell.

### FIELD OF THE INVENTION

The present invention concerns hybrid lattice structures useful in bumpers, pads, cushions, shock absorbers, and other lattice objects produced by additive manufacturing.

### BACKGROUND OF THE INVENTION

Additive manufacturing makes it possible to fabricate a wide variety of geometries that are difficult or impossible to make with legacy manufacturing processes. Lattices in particular have opened up a world of desirable mechanical properties, from better compression and energy absorption properties to lighter weight parts. Popular use cases include replacing standard foam padding with lattices having better stiffness-to-mass ratios, and using superior energy-absorption properties of some lattices to improve protective equipment like helmets and car seats (see, e.g., Bologna, Gillogly, and Ide, US Patent Application Publication Nos. US2020/0215415 and US2020/0100554).

Some lattice structure designs are defined by their unit cell, which may fall into one of two categories: strut and surface based. Strut-based unit cells may consist of a network of struts connected at nodes. Surface-based unit cells may be mathematically defined as the surface connecting set of points for which a given function has a constant value, that is, an isosurface.

One challenge is the vast number of possible lattice structures theoretically available for inclusion in additively manufactured objects. And, depending on the particular object, more than one type of lattice structure can be included in the object (see, e.g., Kabaria and Kurtz, U.S. Pat. No. 10,882,255). When compounded with the broad variety of materials available for making additively manufactured objects, this vast number of theoretical options makes the identification of specific lattice structures useful for specific products challenging. Accordingly, there is a need for new approaches to identifying new and useful lattice structures for additive manufacturing.

### SUMMARY OF THE INVENTION

To identify specific lattices suitable for specific products, a generalized form of the widely studied surface lattice functions that define (for example) the Schwarz-P and gyroid lattice structures can be given by:

$$g ( x , y , z ) = {\sum }_{k = 1}^{N} {w}_{k} \cdot cos ( {f}_{1 k} \cdot x + {s}_{1 k} ) \cdot cos ( {f}_{2 k} \cdot y + {s}_{2 k} ) \cdot cos ( {f}_{3 k} \cdot z + {s}_{3 k} )$$

By tuning the weight (wₖ), frequency (fⱼₖ), and phase-shift parameters (sⱼₖ) in this general form, hybrids of known lattices can be produced, zeroing in on more specifically optimized force profiles. For example, to create a hybrid lattice, a Schwarz-P lattice can be combined with a second lattice to achieve particular tensile and/or mechanical properties, as schematically illustrated in FIG. 1.

Once a few functions g(x,y,z) for different lattice structures are established, this process for blending together shapes differs from the “linear term” process of (Gabrielli et al., Key Engineering Materials, 361-363, pp. 903-906 (2008)) and (Melchels et al., Biomaterials 31, 6909-6916 (2010)) as follows. This method produces a new implicit function (which uniquely defines a surface lattice) by taking the functions for two existing lattices and combining them via linear combination. As an example, given the known Schwarz-P and gyroid functions, a whole continuous family of related lattice structures have been explored by taking linear combinations of the two:

$${g}_{new} ( x , y , z , α ) = α \cdot {g}_{schwarz} ( x , y , z ) + ( 1 - α ) \cdot {g}_{gyroid} ( x , y , z )$$

More generally, for any two surface lattices L1 and L2, one can interpolate between those via:

$${g}_{new} ( x , y , z , α ) = α \cdot {g}_{L 1} ( x , y , z ) + ( 1 - α ) \cdot {g}_{L 2} ( x , y , z )$$

This process is then used to identify new lattices with desirable mechanical properties by choosing two lattices with respective desired properties, then using the above linear combination formula to produce a series of new lattice structures with a blend of the two desired properties.

Wohlgemuth et al., Macromolecules 34, 6083-6089 (2001), consider lattices from specific “space groups” (subsets of the space of surface lattices that have certain symmetries). They describe how to combine specific individual lattices' functions to produce a few new ones that are also in certain space groups. Their goal, however, is to identify candidate microdomain structures in block copolymers as possible inspiration for polymer chemists and polymer physicists, rather than identifying macroscopic lattice structures that, when formed by additive manufacturing of specific materials, give tensile and/or mechanical properties suitable for the additive manufacturing of specific objects, as well as classes of objects or applications for which those hybrid lattice structures are designed.

Lattice structures are also discussed in Al-Ketan, O. and Abu Al-Rub, R. K. (2019), “Multifunctional Mechanical Metamaterials Based on Triply Periodic Minimal Surface Lattices,” Adv. Eng. Mater., 21:1900524 (“Al-Ketan”). Al-Ketan describes a non-uniform lattice, and the use of an interpolation (a function gamma) to specify how a single lattice transitions to different shapes in different spatial regions of the single lattice.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 schematically illustrates a specific example of a hybrid surface lattice generated by interpolating two primary lattice structures.

FIG. 2 is a flow chart illustrating one embodiment of a process as described herein.

FIG. 3 is a schematic illustration of an apparatus for carrying out a process of FIG. 2.

FIG. 4 shows a Schwarz-P surface lattice as FIG. 4A, a gyroid lattice as FIG. 4F, and a series of hybrid lattices FIG. 4B-4E that are sequential progressive interpolations therebetween.

FIG. 5 shows a Schwarz-P surface lattice with a frequency of 2 as FIG. 5A, a Schwarz-P surface lattice with a frequency of 3 as FIG. 5F, and a series of hybrid lattices FIG. 5B-5E that are sequential progressive interpolations therebetween.

FIG. 6 shows a relative of a Schwarz-P surface lattice with greater stiffness along one axis as FIG. 6A, a randomly generated surface lattice as FIG. 6F, and a series of hybrid lattices FIG. 6B-6E that are sequential progressive interpolations therebetween.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

### 1. Additive Manufacturing.

Techniques for additive manufacturing are known. Suitable techniques include, but are not limited to, techniques such as selective laser sintering (SLS), fused deposition modeling (FDM), stereolithography (SLA), material jetting including three-dimensional printing (3DP) and multijet modeling (MJM) (MJM including Multi-Jet Fusion such as available from Hewlett Packard), and others. See, e.g., H. Bikas et al., Additive manufacturing methods and modelling approaches: a critical review, Int. J. Adv. Manuf. Technol. 83, 389-405 (2016).

Resins for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc.

Stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or said advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

After the object is formed, it is typically cleaned as described below, and in some embodiments then further cured, preferably by baking (although further curing may in some embodiments be concurrent with the first cure, or may be by different mechanisms such as contacting to water, as described in U.S. Pat. No. 9,453,142 to Rolland et al.).

### 2. Systems.

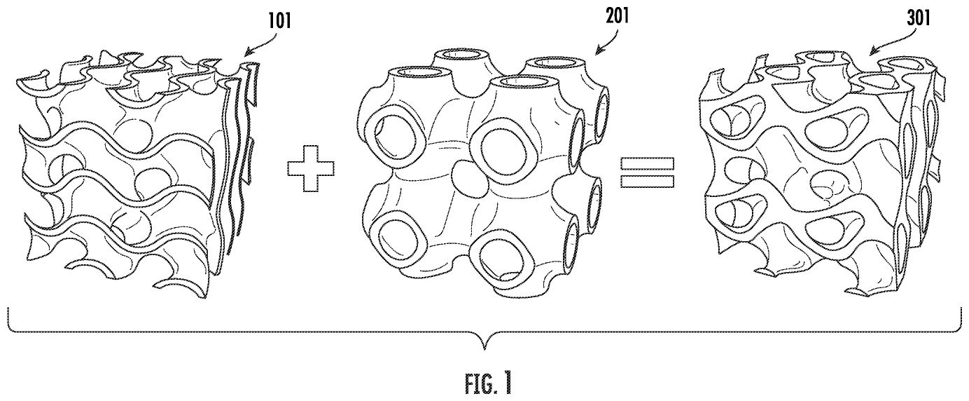

Methods and apparatus for additively manufacturing a three-dimensional object such as those described herein may provide the ability to generate an improved lattice structure or lattice unit cell structure from two different lattice structures or lattice unit cell structures. FIG. 1 schematically illustrates a specific example of a hybrid surface lattice generated by interpolating two primary lattice structures. FIG. 2 is a flow chart illustrating one embodiment of a process as described herein.

Referring to FIGS. 1 and 2, a method (e.g., a computer-implemented method) of generating a surface lattice unit cell having tensile and/or mechanical properties useful for the production of lattice-filled 3D objects by additive manufacturing may include a number of operations.

For example, the method may include receiving, e.g., in a computer, a first lattice structure 101 defining a first surface lattice unit cell (block 11). The method may also include receiving, e.g., in a computer, a second lattice structure 201 defining a second surface lattice unit cell different from said first surface lattice unit cell (block 12). The first lattice structure 101 and/or the second lattice structure 201 may, for example, be represented by a mathematical equation and/or other data representation.

For example, the first and second lattice structures 101, 201 may each independently represented by a formula g(x, y, z), where:

$$g ( x , y , z ) = {\sum }_{k = 1}^{N} {w}_{k} \cdot cos ( {f}_{1 k} \cdot x + {s}_{1 k} ) \cdot cos ( {f}_{2 k} \cdot y + {s}_{2 k} ) \cdot cos ( {f}_{3 k} \cdot z + {s}_{3 k} )$$

In the above equation, N (number of terms) may be a range of from 1 or 2 to 5, 50, 500, or more, wₖ (weight) may be a range of from −1 to 1, normalized so the sum of |wₖ| for k=1 to N sums to 1, f₁ₖ, f₂ₖ, and f₃ₖ (each a frequency) may each independently be pi (π) times any integer of from 0 to 4, 10 or more, and s₁ₖ, s₂ₖ, and s₃ₖ (each a phase shift) may each independently be pi (π) times a real number of from 0 to 1.

The above equation defines an isosurface. The isosurface may be combined with a thickness to define an isovolume that can be used to define and/or manufacture the first and second lattice structures 101, 201. A same isosurface can be combined with different thicknesses to define different first and second lattice structures 101, 201.

Examples of the first and second lattice structures 101, 201 that may be incorporated utilizing the methods and/or systems described herein include, for example, triply periodic surface lattices such as a Schwarz primitive (“Schwarz-P”), Schwarz diamond (“Schwarz-D”), Schoen gyroid (“gyroid”), Double gyroid, Neovius, Schoen FRD (“FRD”), Schoen I-WP (“I-WP”), Schoen O,C-TO (“O,C-TO”), Schwarz CLP (“CLP”), and/or Fischer-Koch S lattice structures. The example list of lattice structures is not intended to limit the embodiments of the present disclosure.

FIG. 1 shows examples of a first lattice structure 101 and a second lattice structure 201, though the embodiments of the present disclosure are not limited to these structures.

The method may further include generating, by interpolating the first and second lattice structures 101, 201 in a computer, a series (e.g., one or more) of unit cell template structures 301 (also referred to herein as a hybrid surface lattice unit cell 301 and/or interpolated lattice structure 301), each member of the series representing a different interpolation of the first and second lattice structures 101, 201 (block 13). As illustrated in FIG. 1, the interpolated lattice structure 301 may be generated based on the first lattice structure 101 and the second lattice structure 201. In some embodiments, the interpolated lattice structure 301 may be a hybrid of the first lattice structure 101 and the second lattice structure 201.

In some embodiments, each member of the series of interpolated lattice structures 301 may be represented by the formula g_{new}(x, y, z, α) that is generated by interpolating the first and second lattice structures 101, 201 according to the formula:

$${g}_{new} ( x , y , z , α ) = α \cdot {g}_{L 1} ( x , y , z ) + ( 1 - α ) \cdot {g}_{L 2} ( x , y , z )$$

where alpha (α) is a real number between zero and one and where the first lattice structure 101 is defined by the formula g_{L1}(x, y, z) and second lattice structure is defined by the formula g_{L2}(x, y, z).

In some embodiments, when interpolating the first and second lattice structures 101, 201, a thickness of the interpolated lattice structure 301 may be adjusted to keep the amount of mass constant for each different lattice structure shape. As used herein, a “thickness” of a lattice structure refers to a thickness of the lattice surfaces (e.g., those defined by the isosurface) rather than an absolute thickness of the lattice unit cell structure. In some embodiments, a goal of the interpolation may be to optimize and/or prioritize stiffness for a fixed mass. Thus, for a given interpolated lattice structure 301 defined by g_{new}(x, y, z, α), multiple interpolated lattice structures 301 may be generated based on varying a thickness of the lattice structure (e.g., to achieve a fixed and/or predetermined mass of the lattice structure).

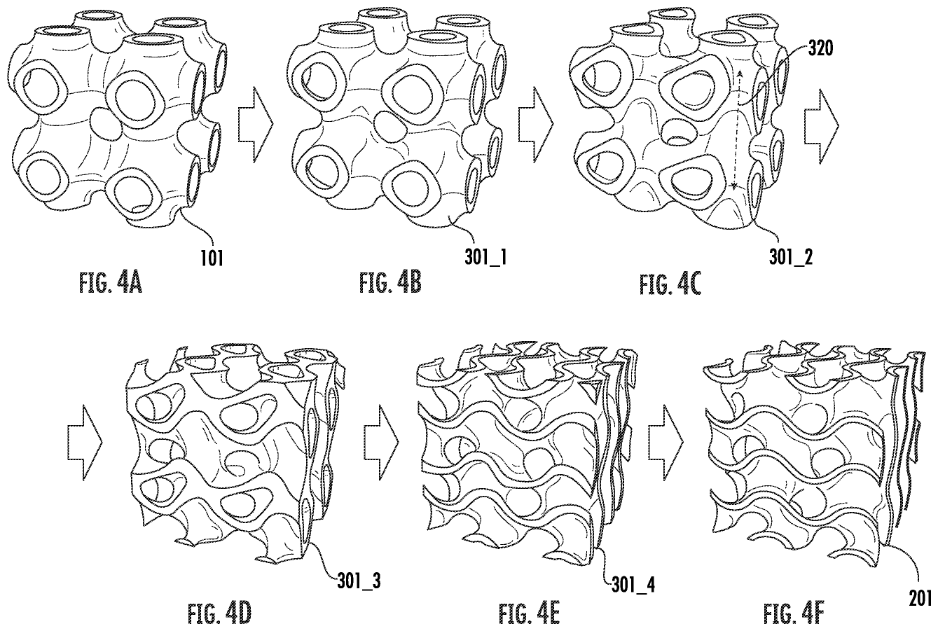

FIGS. 4-6 illustrate examples of the application of the interpolation operation described above (e.g., block 13) to various examples of first and second lattice structures 101, 201. For example, FIGS. 4A to 4F illustrate an example of an interpolation between a Schwarz-P surface lattice and a gyroid lattice. FIG. 4A illustrates the Schwarz-P surface lattice as the first lattice structure 101 and FIG. 4F illustrates the gyroid lattice as the second lattice structure 201. FIGS. 4B-4E illustrate a series of hybrid/interpolated lattices 301_1, 301_2, 301_3, and 301_4 that are interpolations between the first lattice structure 101 (the Schwarz-P surface lattice) and the second lattice structure 201 (the gyroid surface lattice) utilizing sequential variations of alpha (α) according to the formula for g_{new}(x, y, z, α) provided above. Though FIGS. 4B-4E illustrate a series of four interpolations, it will be understood that the present invention is not limited thereto. In some embodiments, more or fewer than four interpolations may be provided.

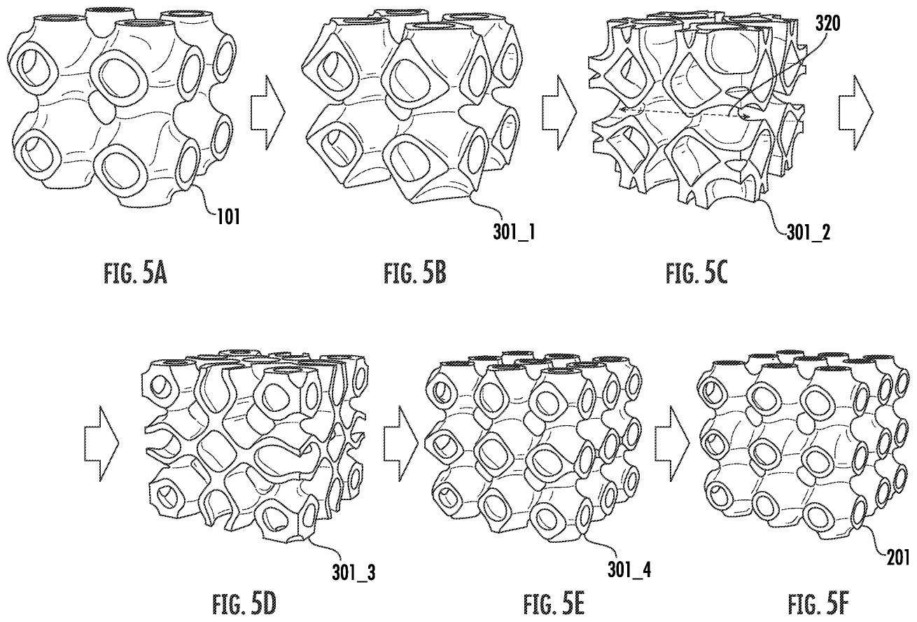

FIGS. 5A to 5F illustrate an example of an interpolation between two variations of a Schwarz-P surface lattice. FIG. 5A illustrates a Schwarz-P surface lattice with a frequency of 2 as the first lattice structure 101 and FIG. 5F illustrates a Schwarz-P surface lattice with a frequency of 3 as the second lattice structure 201. FIGS. 5B-5E illustrate a series of hybrid/interpolated lattices 301_1, 301_2, 301_3, and 301_4 that are interpolations between the first lattice structure 101 (the first Schwarz-P surface lattice) and the second lattice structure 201 (the second Schwarz-P surface lattice) utilizing sequential variations of alpha (α) according to the formula for g_{new}(x, y, z, α) provided above. Though FIGS. 5B-5E illustrate a series of four interpolations, it will be understood that the present invention is not limited thereto. In some embodiments, more or fewer than four interpolations may be provided.

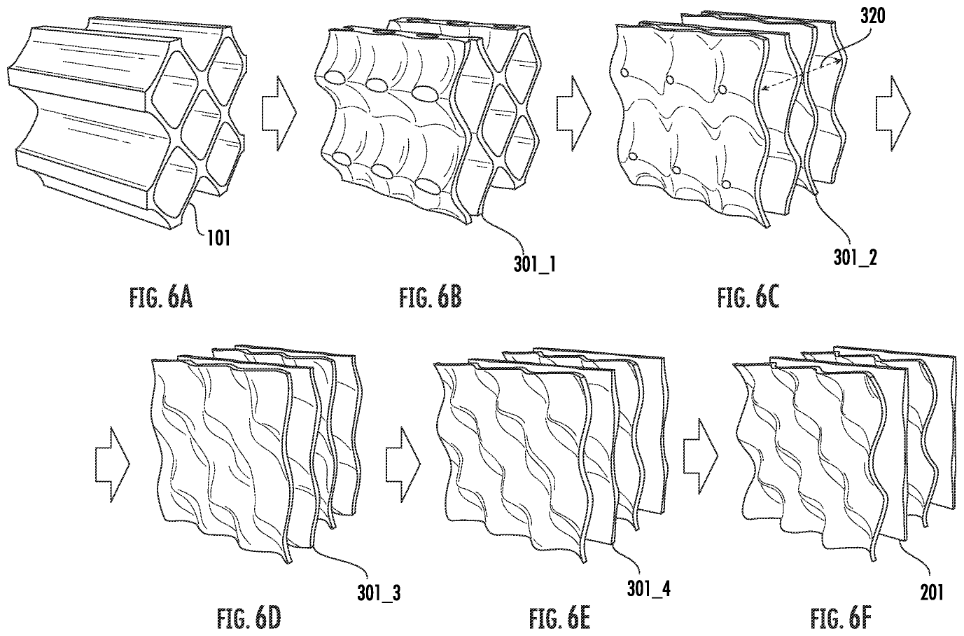

FIGS. 6A to 6F illustrate an example of an interpolation between a Schwarz-P surface lattice and a randomly generated lattice. FIGS. 6A to 6F illustrate that to create a hybrid lattice (e.g., having a greater stiffness along one axis), the lattice structure of a particular Schwarz-P lattice can be combined with that of a second lattice tuned for stiffness in that direction. FIG. 6A illustrates the Schwarz-P surface lattice as the first lattice structure 101 and FIG. 6F illustrates a randomly generated lattice as the second lattice structure 201. FIGS. 6B-6E illustrate a series of hybrid/interpolated lattices 301_1, 301_2, 301_3, and 301_4 that are interpolations between the first lattice structure 101 (the Schwarz-P surface lattice) and the second lattice structure 201 (the randomly generated lattice) utilizing sequential variations of alpha (α) according to the formula for g_{new}(x, y, z, α) provided above. Though FIGS. 6B-6E illustrate a series of four interpolations, it will be understood that the present invention is not limited thereto. In some embodiments, more or fewer than four interpolations may be provided.

Referring to FIGS. 2, the method may further include selecting a subset of the series of unit cell template structures 301 (block 14). The subset may be one or a plurality of interpolated lattice structures 301 from the series generated from the interpolation of said first and second lattice structures 101, 201.

The method may further include determining, e.g., by a computer, tensile and/or mechanical properties (block 15) of the subset of said series of unit cell template structures previously selected (in block 14). The operation of block 15 can be carried out with any software package used for physics simulations, examples of which include, but are not limited to, SfePy, FEniCS, FiPy, and others (see, e.g., R. Cimrman et al., Multiscale finite element calculations in Python using SfePy. Adv Comput Math. (2019); M. Alnaes et al., Archive of Numerical Software, vol. 3 (2015); A. Logg et al., Automated Solution of Differential Equations by the Finite Element Method (Springer, 2012); J. Guyer, et al., FiPy: Partial Differential Equations with Python, Computing in Science & Engineering 11 6-15 (2009)).

The tensile and/or mechanical properties may include, for example, stiffness, energy absorption, energy return, resilience, and/or toughness of the unit cell template structure 301. The mechanical properties may be computed for various deformation modes, examples of which include, but are not limited to, tension, compression, shear, torsion, and bending (see, e.g., L. Gibson et al., Cellular Solids (2nd edition), Cambridge University Press (2014); B. Nagesha et al., “Review on characterization and impacts of the lattice structure in additive manufacturing,” Materials Today. (2020); B. Abali et al., “Additive manufacturing introduced substructure and computational determination of metamaterials parameters by means of the asymptotic homogenization,” Continuum Mechanics and Thermodynamics, (2020)).

In some embodiments, the tensile and/or mechanical properties may be determined with respect to a predefined axis 320 of the interpolated lattice structure 301 and/or an orientation of the interpolated lattice structure 301. The predetermined axis 320 may refer to a longitudinal axis extending within or into the interpolated lattice structure 301. For example, FIGS. 4C, 5C, and 6C illustrate an example of a predefined axis 320 (illustrated as a dashed line) along which tensile and/or mechanical properties of the interpolated lattice structure 301 may be determined. The use of the predetermined axis 320 may allow for the production of products from the interpolated lattice structure 301 that match desired properties along a particular direction (e.g., a direction of impact and/or force application).

According to some embodiments described herein, the determining step illustrated in block 15 may be based on a known material with which the interpolated lattice structure 301 is to be manufactured. For example, the known material may include a polymerized resin, sintered or fused metal, ceramic, and/or polymer particles, etc. Determining the tensile and/or mechanical properties of the interpolated lattice structure 301 may be based, in some embodiments, on each unit cell template structure in the subset of the series of interpolated lattice structure 301. In some embodiments, determining the tensile and/or mechanical properties of the interpolated lattice structure 301 may be based on an elastic modulus for the known material of the interpolated lattice structure 301 (e.g., a Young's modulus, shear modulus, bulk modulus or the like). In some embodiments, determining the tensile and/or mechanical properties of the interpolated lattice structure 301 may be based on a measure of the Poisson effect for the known material of the interpolated lattice structure 301 (e.g., a Poisson's ratio). In some embodiments, the elastic modulus and/or the measure of the Poisson effect are as defined at a given temperature. For example, the given temperature may be selected from within a defined operating range for a 3D object using (e.g., including and/or filled with) the interpolated lattice structure 301.

In some embodiments, the interpolated lattice structures 301 may have a characteristic tensile and/or mechanical property (e.g., stiffness, energy absorption, energy return, resilience, toughness) along a predefined axis 320 therein not achieved by either of the first surface lattice structure 101 or the second surface lattice structure 201 when formed from the same material as the interpolated lattice structures 301.

Referring to FIG. 2, the method may further include selecting a candidate surface lattice unit cell structure 301 from the series of interpolated lattice structures 301 (block 16) having tensile and/or mechanical properties useful for the production of lattice-filled 3D objects by additive manufacturing.

In some embodiments, the selecting operation of block 16 may be carried out by selecting the candidate surface lattice unit cell structure 301 from a subset of the interpolated lattice structures 301 based on the candidate surface lattice unit cell structure 301 having tensile and/or mechanical properties that achieve a predefined tensile and/or mechanical property goal (e.g., a minimum stiffness or energy absorption for a force applied to the unit cell in a predetermined orientation). In some embodiments, the candidate surface lattice unit cell structure 301 may be selected from the subset of the interpolated lattice structures 301 based on which surface lattice unit cell structure 301 best meets the predefined tensile and/or mechanical property goal. In some embodiments, the candidate surface lattice unit cell structure 301 may be selected from all of the interpolated lattice structures 301 that meet the predefined tensile and/or mechanical property goal based on additional criteria such as, for example, complexity of manufacturing, cost of manufacturing, and/or other features.

The method may further include additively manufacturing (block 21) a 3D object comprising repeating unit cells of the candidate surface lattice unit cell structure 301 selected in block 16. In some embodiments, additively manufacturing the object may be preceded by filling at least a portion of a polyhedral (e.g., tetrahedral) mesh representing the 3D object with the candidate surface lattice unit cell structure 301. In some embodiments, the additive manufacturing operation (block 21) may be carried out by selective laser sintering (SLS), fused deposition modeling (FDM), stereolithography (SLA), three-dimensional printing (3DP), or multijet modeling (MJM). In some embodiments, the candidate surface lattice unit cell 301 of the 3D object that is additively manufactured is comprised of a polymer (including polymer blends), metal, ceramic, or composite thereof. In some embodiments, the 3D object is comprised of, consists of, or consists essentially of the reaction products of a dual cure polymer resin.

In some embodiments, the filled polyhedral mesh of the 3D object may be represented as a data structure. The data structure may be translated to one or more instruction files in a format that can be provided to an additive manufacturing apparatus to generate the 3D object. For example, the filled polyhedral mesh may be represented by an instruction file in an STL file format. Numerous alternatives to STL files can be used, including but not limited to PLY, OBJ, 3MF, AMF, VRML, X3G, and FBX files, and others as set forth in Barnes et al., US Patent Application Pub. No. 20190026406 (Jan. 24, 2019) and Mummidi et al., US Patent Application Pub. No. 20180113437 (Apr. 26, 2018). The instruction file may include one or more data and/or instructions sets that, when interpreted by an additive manufacturing apparatus or a processor associated therewith, cause the additive manufacturing apparatus to control the physical elements of the additive manufacturing apparatus to manufacture the 3D object. Thus, the data representation(s) of the candidate surface lattice unit cell structure 301 and/or the polyhedral mesh filled with the candidate surface lattice unit cell structure 301 may be provided as a tangible non-transitory computer-readable medium that is configured to provide physical control of an additive manufacturing apparatus.

Referring to FIG. 2, the method may further include determining (e.g., by physical testing) the tensile and/or mechanical properties (block 22) of the additively manufactured object including the candidate surface lattice unit cell structure 301, and then optionally, but in some embodiments preferably, comparing the tensile and/or mechanical properties determined in block 22 with the tensile and/or mechanical properties determined for said candidate surface lattice unit cell 301 selected in block 16. Optionally, but in some embodiments preferably, the method may include comparing the tensile and/or mechanical properties determined in block 22 with a predefined tensile and/or mechanical property goal (block 23) for the 3D object.

Though the operations of blocks 15, 22, and 23 described herein with respect to FIG. 2 have focused on analysis of tensile and/or mechanical properties, it will be understood that the embodiments described herein are not limited thereto. In some embodiments, additional and/or alternate properties of the lattice structures may be analyzed/utilized to design and/or fabricate the improved interpolated lattice structure 301.

### 3. Apparatus.

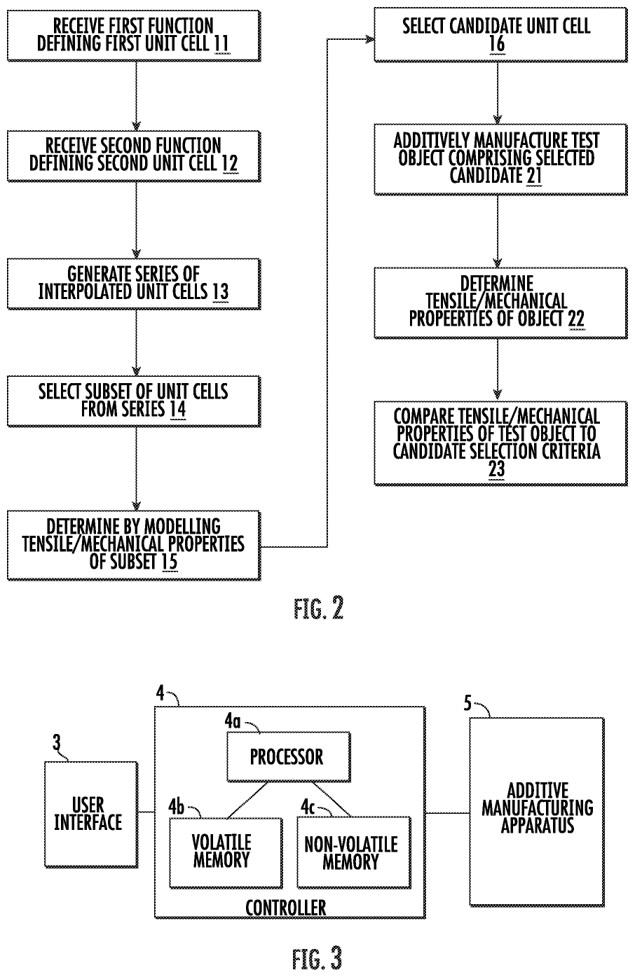

An apparatus for carrying out a non-limiting embodiment of the present invention is schematically illustrated in FIG. 3. Such an apparatus includes a user interface 3 for inputting instructions (such as selection of an object to be produced, and selection of features to be added to the object), a controller 4, and a stereolithography apparatus 5 such as described above. An optional washer (not shown) can be included in the system if desired, or a separate washer can be utilized. Similarly, for dual cure resins, an oven (not shown) can be included in the system, although a separately-operated oven can also be utilized.

Connections between components of the system can be by any suitable configuration, including wired and/or wireless connections. The components may also communicate over one or more networks, including any conventional, public and/or private, real and/or virtual, wired and/or wireless network, including the Internet.

The controller 4 may be of any suitable type, such as a general-purpose computer. Typically, the controller will include at least one processor 4a, a volatile (or “working”) memory 4b, such as random-access memory, and at least one non-volatile or persistent memory 4c, such as a hard drive or a flash drive. The controller 4 may use hardware, software implemented with hardware, firmware, tangible computer-readable storage media having instructions stored thereon, and/or a combination thereof, and may be implemented in one or more computer systems or other processing systems. The controller 4 may also utilize a virtual instance of a computer. As such, the devices and methods described herein may be embodied in any combination of hardware and software that may all generally be referred to herein as a “circuit,” “module,” “component,” and/or “system.” Furthermore, example embodiments of the present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any non-transient tangible medium that can contain, or store a program for use by or in connection with an instruction execution system, apparatus, or device.

The at least one processor 4a of the controller 4 may be configured to execute computer program code for carrying out operations for aspects of the present invention, which computer program code may be written in any combination of one or more programming languages, including an object oriented programming language such as Java, Scala, Smalltalk, Eiffel, JADE, Emerald, C++, C#, VB.NET, or the like, conventional procedural programming languages, such as the “C” programming language, Visual Basic, Fortran 2003, COBOL 2002, PHP, ABAP, dynamic programming languages such as Python, PERL, Ruby, and Groovy, or other programming languages.

The at least one processor 4a may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks.

Connections between internal components of the controller 4 are shown only in part and connections between internal components of the controller 4 and external components are not shown for clarity, but are provided by additional components known in the art, such as busses, input/output boards, communication adapters, network adapters, etc. The connections between the internal components of the controller 4, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Advanced Technology Attachment (ATA) bus, a Serial ATA (SATA) bus, and/or an Institute of Electrical and Electronics Engineers (IEEE) standard 1394 bus, also called “Firewire.”

The user interface 3 may be of any suitable type. The user interface 3 may include a display and/or one or more user input devices. The display may be accessible to the at least one processor 4a via the connections between the system components. The display may provide graphical user interfaces for receiving input, displaying intermediate operation/data, and/or exporting output of the methods described herein. The display may include, but is not limited to, a monitor, a touch screen device, etc., including combinations thereof. The input device may include, but is not limited to, a mouse, keyboard, camera, etc., including combinations thereof. The input device may be accessible to the at least one processor 4a via the connections between the system components. The user interface 3 may interface with and/or be operated by computer readable software code instructions resident in the volatile memory 4b that are executed by the processor 4a.

Example embodiments of the present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor (e.g., processor 4a) of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

### 4. Products.

An additively manufactured product according to embodiments of the present invention may include a lattice including repeating unit cells, the repeating unit cells including a hybrid (e.g., interpolated) surface lattice unit cell 301. The hybrid surface lattice unit cell 301 may have a configuration represented by an interpolation of a first and second surface lattice unit cell 101, 201. The hybrid surface lattice unit cell 301 may have a characteristic tensile and/or mechanical property (e.g., stiffness, energy absorption, energy return, resilience, toughness) along a predefined axis 320 therein not achieved by either said first or second surface lattice unit cell 101, 201 when formed from the same material as the hybrid surface lattice unit cell 301. The hybrid surface lattice unit cell 301 may be selected and/or produced by one or more steps of the method described herein.

In some embodiments, the product may be fabricated by the process of selective laser sintering (SLS), fused deposition modeling (FDM), stereolithography (SLA), three-dimensional printing (3DP), or multijet modeling (MJM).

In some embodiments, the product may be or include a cushion (e.g., a body pad such as a helmet liner, a seat cushion, saddle, headrest, etc.) or a shock absorber (e.g., an automotive or aerospace body panel or body panel insert, etc.). In some embodiments, the product is comprised of, consists of, or consists essentially of the reaction products of a dual cure polymer resin. In some embodiments, the product includes a brace, arm, link, shock absorber, cushion or pad (e.g., a bed or seat cushion; a wearable protective device such as a shin guard, knee pad, elbow pad, sports brassiere, bicycling shorts, backpack strap, backpack back pad (i.e., that pad or portion that rests against the wearer's back), neck brace, chest protector, protective vest, protective jacket, slacks, etc., including an insert therefor; an automotive or aerospace panel, bumper, or component; etc.). In some embodiments, the product comprises a footwear insole, midsole, or orthotic insert, a bicycle saddle, or a helmet liner.

In some embodiments, the lattice of the product may include a conformal lattice. In some embodiments, the lattice may be formed of a polymer (including polymer blends), metal, ceramic, or composite thereof. In some embodiments, the lattice may be rigid, flexible, or elastic.

The foregoing is illustrative of the present invention, and is not to be construed as limiting thereof. The invention is defined by the following claims, with equivalents of the claims to be included therein.

1. An additively manufactured product, the product comprising:
a lattice including repeating unit cells, the repeating unit cells including a hybrid surface lattice unit cell, the hybrid surface lattice unit cell having a configuration represented by an interpolation of a first and second surface lattice unit cell, the hybrid surface lattice unit cell having a characteristic tensile and/or mechanical property along a predefined axis therein not achieved by either said first or second surface lattice unit cell when formed from the same material as said hybrid surface lattice unit cell.

2. The product of claim 1, wherein said product is produced by the process of selective laser sintering (SLS), fused deposition modeling (FDM), stereolithography (SLA), three-dimensional printing (3DP), or multijet modeling (MJM).

3. The product of claim 1, wherein said product comprises a cushion or a shock absorber.

4. The product of claim 1, wherein said lattice comprises a conformal lattice.

5. The product of claim 1, wherein said lattice is comprised of a polymer or polymer blend, metal, ceramic, or composite thereof.

6. The product of claim 1, wherein said product is comprised of, consists of, or consists essentially of the reaction products of a dual cure polymer resin.

7. The product of claim 1, wherein said lattice is rigid.

8. The product of claim 1, wherein said lattice is flexible or elastic.

9. The product of claim 1, wherein said product comprises a brace, arm, link, shock absorber, cushion or pad, neck brace, chest protector, protective vest, protective jacket, or slacks.

10. The product of claim 1, wherein said product comprises a footwear insole, midsole, or orthotic insert, a bicycle saddle, or a helmet liner.

11. The product of claim 1, wherein said hybrid surface lattice unit cell is produced by a method comprising:
(a) receiving, in a computer, a first lattice structure defining a first surface lattice unit cell;
(b) receiving, in a computer, a second lattice structure defining a second surface lattice unit cell different from said first surface lattice unit cell;
(c) generating, by interpolating said first and second lattice structures in a computer, a series of unit cell template structures, each member of said series representing a different interpolation of said first and second lattice structures;
(d) determining, by a computer, tensile and/or mechanical properties of at least a subset of said series of unit cell template structures; and
(e) selecting, from said at least a subset, a candidate surface lattice unit cell having tensile and/or mechanical properties useful for the production of lattice-filled 3D objects by additive manufacturing.

12. A computer-implemented method of generating a surface lattice unit cell having tensile and/or mechanical properties useful for the production of lattice-filled 3D objects by additive manufacturing, the method comprising:
(a) receiving, in a computer, a first lattice structure defining a first surface lattice unit cell;
(b) receiving, in a computer, a second lattice structure defining a second surface lattice unit cell different from said first surface lattice unit cell;
(c) generating, by interpolating said first and second lattice structures in a computer, a series of unit cell template structures, each member of said series representing a different interpolation of said first and second lattice structures;
(d) determining, by a computer, tensile and/or mechanical properties of at least a subset of said series of unit cell template structures; and
(e) selecting, from said at least a subset, a candidate surface lattice unit cell having tensile and/or mechanical properties useful for the production of lattice-filled 3D objects by additive manufacturing.

13. The method of claim 12, wherein said first and second lattice structures are each independently represented by a formula g(x, y, z), where:
$$g ( x , y , z ) = {\sum }_{k = 1}^{N} {w}_{k} \cdot cos ( {f}_{1 k} \cdot x + {s}_{1 k} ) \cdot cos ( {f}_{2 k} \cdot y + {s}_{2 k} ) \cdot cos ( {f}_{3 k} \cdot z + {s}_{3 k} ) ;$$
and:
N (number of terms) is a range of from 1 or 2 to 5, 50, 500, or more;
wₖ (weight) is a range of from −1 to 1, normalized so the sum of |wₖ| for k=1 to N sums to 1; and
f₁ₖ, f₂ₖ, and f₃ₖ are frequencies in which each frequency f₁ₖ, f₂ₖ, and f₃ₖ is independently pi (π) times any integer of from 0 to 4, 10 or more; and
s₁ₖ, s₂ₖ, and s₃ₖ are phase shifts such that each phase shift s₁ₖ, s₂ₖ, and s₃ₖ is independently pi (π) times a real number of from 0 to 1.

14. The method of claim 13, wherein:
said first lattice structure is defined by the formula g_{L1}(x, y, z);
said second lattice structure is defined by the formula g_{L2}(x, y, z);
each member of said series is defined by the formula g_{new}(x, y, z, α); and
said generating of said series is carried out by interpolating said first and second lattice structures according to the formula:
$${g}_{new} ( x , y , z , α ) = α \cdot {g}_{L 1} ( x , y , z ) + ( 1 - α ) \cdot {g}_{L 2} ( x , y , z ) ,$$
where alpha (α) is a real number between zero and one.

15. The method of claim 12, wherein said candidate surface lattice unit cell is comprised of a known material, and said determining step (d) is carried out based on:
(i) each unit cell template structure in said subset,
(ii) an elastic modulus for said known material, and
(iii) a measure of the Poisson effect for said known material.

16. The method of claim 15, wherein said elastic modulus and/or said measure of the Poisson effect are as defined at a given temperature, said temperature within a defined operating range for said lattice filled 3D objects.

17. The method of claim 12, wherein said selecting step (e) is carried out by selecting the candidate surface lattice unit cell from said at least a subset based on the candidate surface lattice unit cell having tensile and/or mechanical properties that achieve a predefined tensile and/or mechanical property goal.

18. The method of claim 12, further comprising filling at least a portion of a polyhedral mesh representing a 3D object with the candidate surface lattice unit cell selected in step (e).

19. The method of claim 12, further comprising the steps of:
(f) additively manufacturing an object comprising repeating unit cells of said candidate surface lattice unit cell selected in step (e), then
(g) determining, by physical testing, the tensile and/or mechanical properties of said additively manufactured object; and then
(h) optionally comparing the tensile and/or mechanical properties determined in step (g) with the tensile and/or mechanical properties determined for said candidate surface lattice unit cell selected in step (e); and
(i) optionally comparing the tensile and/or mechanical properties determined in step (g) with a predefined tensile and/or mechanical property goal.

20. The method of claim 19, wherein said additive manufacturing step (f) is carried out by selective laser sintering (SLS), fused deposition modeling (FDM), stereolithography (SLA), three-dimensional printing (3DP), or multijet modeling (MJM).

21. The method of claim 19, wherein said candidate surface lattice unit cell of said object that is additively manufactured is comprised of a polymer or a polymer blend, metal, ceramic, or a composite thereof.

22. The method of claim 21, wherein said object is comprised of, consists of, or consists essentially of the reaction products of a dual cure polymer resin.

23. A computer program product for operating an electronic device comprising a non-transitory computer readable storage medium having computer readable program code embodied in the medium that when executed by a processor causes the processor to perform operations comprising:
(a) receiving, in a computer, a first lattice structure defining a first surface lattice unit cell;
(b) receiving, in a computer, a second lattice structure defining a second surface lattice unit cell different from said first surface lattice unit cell;
(c) generating, by interpolating said first and second lattice structures in a computer, a series of unit cell template structures, each member of said series representing a different interpolation of said first and second lattice structures;
(d) determining, by a computer, tensile and/or mechanical properties of at least a subset of said series of unit cell template structures; and
(e) selecting, from said at least a subset, a candidate surface lattice unit cell having tensile and/or mechanical properties useful for the production of lattice-filled 3D objects by additive manufacturing.

24. (canceled)
